(19) United States
(12) Patent Application Publication
(10) Pub. No.: US 2024/0152868 A1
(43) Pub. Date: May 9, 2024

(54) Systems and Methods for Automating the Creation of Collaborative Boards Based on Different Triggering Events

(71) Applicant: Kudoboard, Inc., Denver, CO (US)

(72) Inventors: Aaron Rubens, Chicago, IL (US); Kyler Deutmeyer, Denver, CO (US)

(73) Assignee: Kudoboard, Inc., Denver, CO (US)

(21) Appl. No.: 18/052,790

(22) Filed: Nov. 4, 2022

(51) Int. Cl. G06Q 10/101; G06F 40/30; G06T 11/60

(52) U.S. Cl. CPC G06Q 10/101; G06F 40/30; G06T 11/60

(57) ABSTRACT

A collaboration system automatically detects an achievement, milestone, state change, and/or other triggering event associated with a particular recipient, solicits contributions to recognize or celebrate the triggering event from a select set of individuals that have established relevant relationships with the particular recipient, and generates a collaboration board by arranging the contributions based on the relationships and the sentiment expressed in the contributions. The resulting collaboration board presents the contributions in a single view, at the same time, and in an arrangement that elicits the strongest emotional response from the particular recipient based on expressive contributions from contributors having the most important relationships with the particular recipient being topmost and frontmost in the collaboration board.

### BACKGROUND

Paper cards provide a physical medium on which different people express their thoughts, praise, sentiment, and/or provide other contributions towards recognizing an achievement or event associated with another. Paper cards are mostly limited to textual contributions, and are physically passed amongst the contributors in order to receive their individual contributions.

Social media provides a digital medium through which different people provide their thoughts, praise, sentiment, and/or other contributions to another. The social media posts support textual contributions as well as audio, video, interactive, graphical (e.g., memes, gifs, etc.), and/or other expressive formats. However, the posts from the different contributors remain separate from one another and are presented one by one in a list and/or in the order they are received by the social media platform. The social media presentation therefore loses the overwhelming emotional impact caused by opening a paper card and seeing all the contributions from the different contributors at one time and/or in one view. Moreover, the social media platforms require the receiver to manually identify a birthday or other special occasion that they want recognized, and the social media platforms then disseminate those manually identified occasions to others in an attempt to induce the contributions from others.

### BRIEF DESCRIPTION OF THE DRAWINGS

FIG. 1 illustrates an example collaborative board that is generated by the collaboration system in accordance with some embodiments presented herein.

FIG. 2 illustrates a conversion of the collaborative board from a digital or online medium to a physical or printed medium in accordance with some embodiments presented herein.

FIG. 3 illustrates an example architecture for the automated creation of collaborative boards based on different triggering events or updated states in accordance with some embodiments presented herein.

FIG. 4 presents a process for dynamically customizing the content, targeted contributing users, and arrangement of received contributions for a collaborative board in accordance with some embodiments presented herein.

FIG. 5 illustrates an example of different collaborative board templates for different configured states or events in accordance with some embodiments presented herein.

FIG. 6 illustrates an example of the intelligent contribution curation performed by the collaboration system in accordance with some embodiments presented herein.

FIG. 7 illustrates an example of verifying the quality of an automatically generated collaborative board in accordance with some embodiments presented herein.

FIG. 8 presents a process for assessing user state from the generation of collaborative board in accordance with some embodiments presented herein.

FIG. 9 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and methods for automating the creation of collaborative boards based on different triggering events. The systems and methods include a collaboration system that performs a bulk generation of customized collaborative boards for different recipients by interfacing with external systems that track various events or state change associated with each recipient. The collaboration system automatically generates a collaborative board for a particular recipient in response to detecting an achievement, milestone, state change, and/or other triggering event associated with the particular recipient in the data tracked by the external systems. Generating the collaborative board includes customizing thematic content for the collaborative board based on the detected triggering event, selecting a customized set of contributors to add to the thematic content of the collaborative board based on associations between the customized set of contributors and the particular recipient, and/or assembling the contributions provided the customized set of contributors within the collaborative board based on sentiment, importance, and/or other criteria associated with an intelligent curation of the contributions.

In this manner, the collaboration system preserves the emotional response that is elicited from opening a paper card and seeing all contributions together in one view at one time while incorporating and/or enhancing the card generation features of a social media or other online platform. However, unlike a social media platform that blasts birthday notification and/or other recipient identified occasions to all “friends” or established contacts of the recipients and that presents the posts from each contact as they are received or generated, the collaboration system automatically detects the occasions, and performs a targeted notification of the detected occasions to a customized set of contributors that are selected based on dynamically determined associations between the recipient, the detected occasions, and the customized set of contributors. The collaboration system curates (e.g., arranges, organizes, orders, positions, etc.) the contributions received from the customized set of contributors across the generated collaborative board based on the dynamically determined associations. The collaboration system presents the curated contributions in a single interface and/or medium to the recipient in a manner that creates the same emotional response as opening a paper card and seeing all the contributions together at one time in one view.

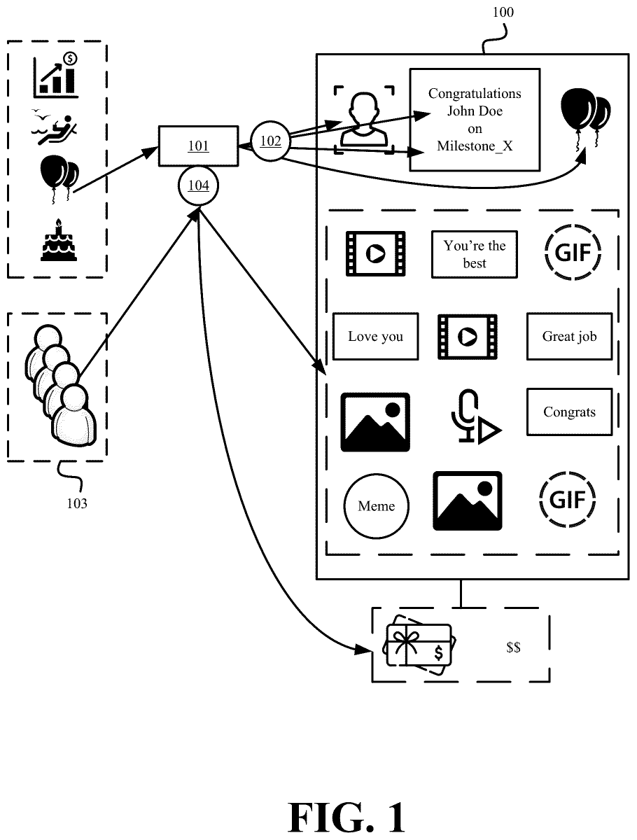

FIG. 1 illustrates an example collaborative board 100 that is generated by the collaboration system in accordance with some embodiments presented herein. Collaborative board 100 includes thematic content that is selected and entered (at 102) by collaboration system 101, and contributions provided (at 104) by different contributors 103 that were selected by collaboration system 101 based on their relationships to the recipient.

The thematic content includes a message, graphic, or other expression that identifies the event or occasion being recognized or celebrated in collaborative board 100, and the recipient associated with the event or occasion. For instance, collaboration system 101 automatically populates collaborative board 100 with the name and/or a picture of the recipient and content for the event or occasion being recognized or celebrated.

The contributions from contributors 103 include textual, audio, video, graphical, interactive, and/or other content that individual contributors 103 submit for inclusion in collaborative board 100 and/or to recognize or celebrate the event or occasion associated with the recipient. Collaboration system 101 intelligently arranges the contributions to maximize the emotional response elicited from the recipient upon viewing the contributions together on collaborative board 100 at one time and/or in one view.

In some embodiments, the contributions include financial or monetary contributions. In some such embodiments, collaboration system 101 pools the financial or monetary contributions made by different contributors 103, and associates the total amount to collaborative board 100. The total amount of financial or monetary contributions are then transferred to the recipient along with collaborative board 100 in the form of a direct bank transfer, a gift card, cryptocurrency, and/or other forms of financial compensation. For instance, upon a recipient opening collaborative board 100, the monetary contributions may be transferred to an account associated with the recipient. Alternatively, the monetary contributions may be transferred to an account that is associated with an identifier (e.g., email account, telephone number, etc.) that receives collaborative board 100. In some embodiments, collaborative board 100 may include a link for redeeming or transferring the funds.

Collaboration system 101 generates collaborative board 100 as an online medium that is accessible via a network link or identifier and a network connected user device. The online medium supports the contributions in the different formats. For instance, some contributors contribute a congratulatory text message by typing or submitting the text message through the online medium, other contributors record and upload a video message to the online medium, and other contributors select and upload memes or gifs (e.g., images or video clips of others with or without textual commentary) to the online medium. In some embodiments, the online medium corresponds to a customized website that is hosted by collaboration system 101 and that is accessible at a specific Uniform Resource Locator (“URL”).

In some embodiments, collaboration system 101 converts the digital representation of collaborative board 100 from the online medium to a physical medium. In some such embodiments, collaboration system 101 prints the collaborative board 100 to a paper card, poster, book, and/or other physical medium. Converting the digital representation may include resizing or rearranging the contributions, selecting a thumbnail or image from a video message to represent the video message, and performing other conversions of the contributions so that they fit and are expressive in the static format of the physical medium.

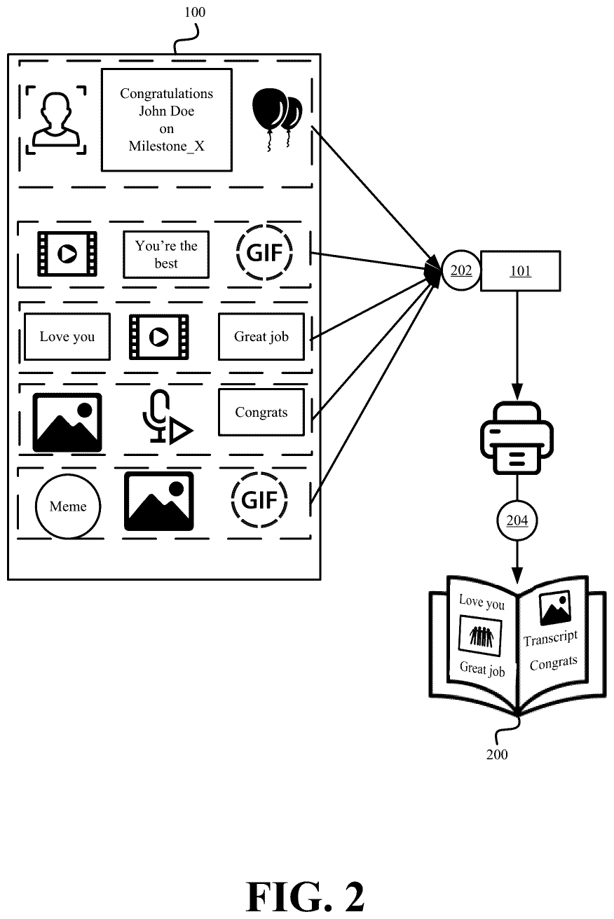

FIG. 2 illustrates a conversion of collaborative board 100 from a digital or online medium to a physical or printed medium in accordance with some embodiments presented herein. As shown in FIG. 2, collaboration system 101 partitions (at 202) the digital or online medium of collaborative board 100 for printing (at 204) on different pages of physical book 200.

The physical or printed medium of collaborative board 100 (e.g., book 200) may be presented to a recipient at a celebratory gathering. Specifically, the physical or printed medium may be wrapped or sealed in an envelope so that the gathered contributors and/or others can witness the emotional response of the recipient upon opening the physical or printed medium and viewing the contributions together at one time.

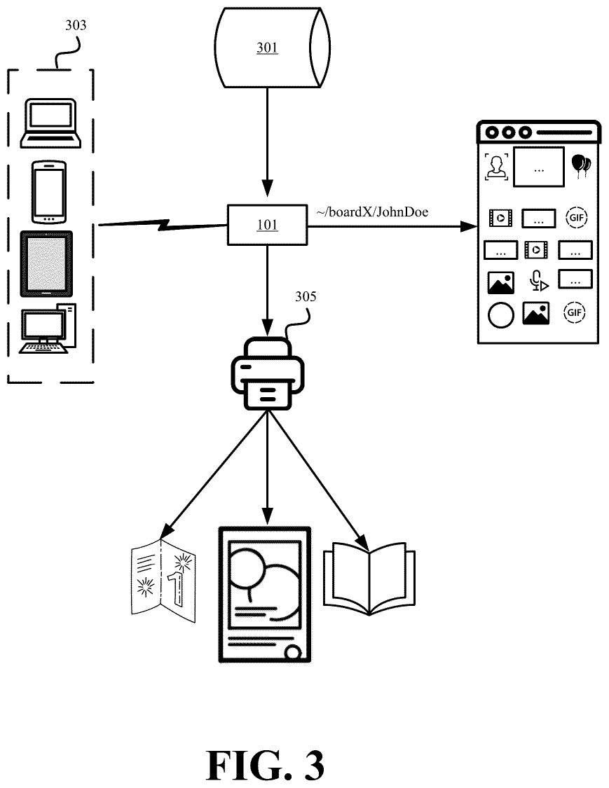

FIG. 3 illustrates an example architecture for the automated creation of collaborative boards based on different triggering events or updated states in accordance with some embodiments presented herein. Collaboration system 101 includes one or more devices or machines with hardware processors, memory, storage, network connectivity, and/or other resources for creating, storing, and presenting the collaborative boards for different recipients.

Collaboration system 101 connects to and/or interfaces with one or more user information systems, user directories, human resource systems, contact management systems, communication (e.g., email, text message, instant message, conferencing systems, etc.) suites, and/or other external systems 301. External systems 301 include databases, data repositories, application programming interfaces (“APIs”), and/or other storage mediums or devices that track state changes, events, and relationships between individuals.

The tracked state changes or events include changes in title (e.g., promotions or demotions), performance statistics (e.g., number of sales in a month, project completion dates, project release dates, etc.), anniversary dates, birthdays, and/or milestones or achievements reached (e.g., obtaining new accreditations or credentials, graduation, reaching sales or performance targets, worked on projects that achieve revenue or usage milestones, etc.). External systems 301 may track any desired statistic, metric, state, or event, and collaboration system 101 may generate a collaborative board for different users in response to the statistics, metrics, states, or events reaching or satisfying various configured value, conditions, and/or thresholds.

The tracked relationships include employee hierarchies (e.g., identification of the company executives, C-suite employees, managers, and employees under different managers), users that work on the same projects, users on the same teams, users in different departments or roles (e.g., marketing, sales, engineering, support, etc.), familial relationships, and/or other business or personal relationships amongst users. In some embodiments, the relationships are tracked based on interactions or engagements between different users. For instance, the tracked relationships for a particular user may include the most frequently accessed contacts of that particular user, wherein the most frequently accessed contacts are determined from phone call lists, email recipients, text message recipients, and/or other non-intrusive or permitted monitoring of communications between the particular user and other users.

Collaboration system 101 also connects to and/or interfaces with one or more user devices 303. Collaboration system 100 connects to and/or interfaces with user devices 303 over a data network via one or more applications, websites, user interfaces, and/or APIs. In some embodiments, collaboration system 101 obtains an email address, telephone number, network address, URL, social media handle, and/or other network identifier for communicating with user devices 303 of different users from external systems 301.

Collaboration system 101 selectively targets and solicits different user devices 303 for contributions to collaborative boards that are being generated for different recipients. Collaboration system 101 also transmits and presents completed collaborative boards to the recipients via their respective user devices 303.

In some embodiments, collaboration system 101 connects to printer 305. Printer 305 includes one or more devices that print the completed collaborative boards onto different physical mediums such as cards, posters, books, and the like.

Collaboration system 101 leverages the state changes, events, and relationships tracked within external systems 301 for the selective and targeted bulk generation of collaborative boards. Specifically, collaboration system 101 automatically determines when to generate a collaborative board, without human intervention, for one or more recipients based on state changes and updated events within external systems 301, custom thematic content to enter into the collaborative board based on the state changes and updated events, a specifically targeted list of contributors to request contributions from based on tracked relationships between the contributors, the one or more recipients, and the state changes or updated events triggering the collaborative board creation, and an automated curation or organization of the received contributions based on the tracked relationships. In other words, collaboration system 101 does not create the same collaborative board, target the same users, and arrange the contributions in the same manner for every collaborative board. Rather, collaboration system 101 dynamically customizes the content for each board, the targeted users that contribute to each board, and the arrangement of the received contributions for each collaborative board based on the different state changes, events, and relationships tracked within external systems 301.

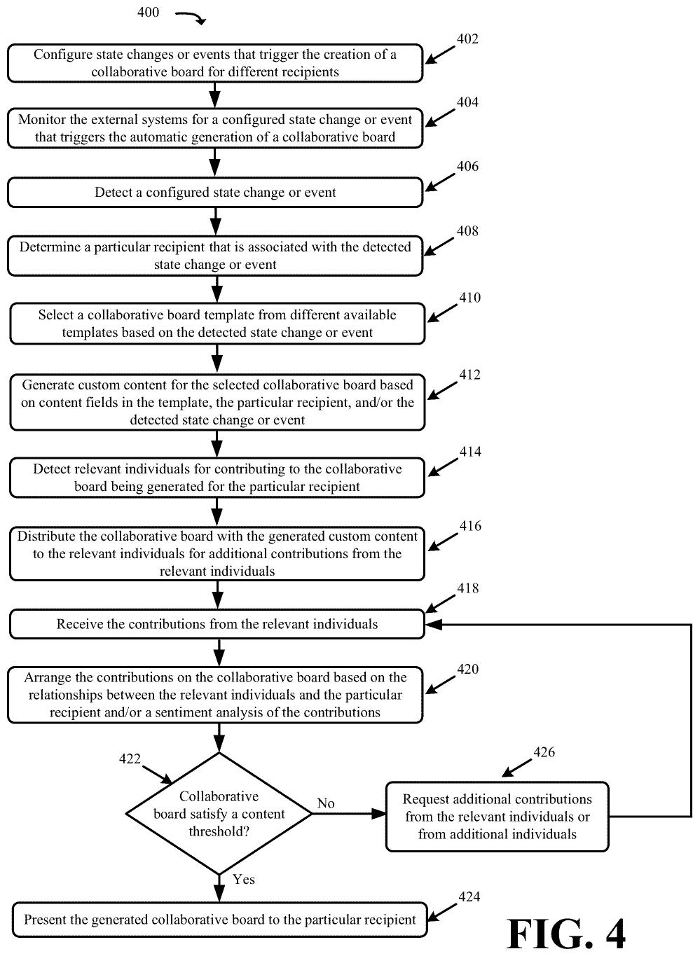

FIG. 4 presents a process 400 for dynamically customizing the content, targeted contributing users, and arrangement of received contributions for a collaborative board in accordance with some embodiments presented herein. Process 400 is implemented by collaboration system 101.

Process 400 includes configuring (at 402) state changes or events that trigger the creation of a collaborative board for different recipients. Different entities (e.g., companies, teams, organizations, families, and/or other groups that want to recognize or celebrate accomplishments or milestones of its members) may configure (at 402) collaboration system 101 to generate collaborative boards in response to different state changes or events that are important to those entities. For instance, a first entity may configure (at 402) collaboration system 101 to generate collaborative boards to recognize work anniversaries, and a second entity may configure (at 402) collaboration system 101 to generate collaborative boards to recognize sales milestones or specific performance goals set for different employees. Collaboration system 101 may create configuration files for different entities in order to customize the collaborative board creation according to the state changes or events that are important to each entity.

Configuring (at 402) the state changes or events includes specifying values, conditions, or thresholds for different states or events that trigger the collaborative board creation when met or satisfied. For instance, a configured state change condition may include selecting the hire date and setting a condition that triggers the creation of the collaborative board when the current month and day is one month before the hire month and day.

Process 400 includes monitoring (at 404) the external systems for a configured state change or event that triggers the automatic generation of a collaborative board. In some embodiments, collaboration system 101 identifies the database records that track the configured state changes or events, and periodically (e.g., hourly, daily, weekly, monthly, etc.) monitors (at 404) those database records for changes or values that satisfy the values, conditions, or thresholds set for a configured state change or event. In some embodiments, collaboration system 101 receives a notification from external systems 301 whenever a file or data instance is updated, and collaboration system 101 inspects the updated data to determine if the updated data satisfies a value, condition, or threshold set for a configured state change or event. In some embodiments, collaboration system 101 is provided access to various files or records of external systems 301 that contain or track the states or events that may trigger the creation of a collaborative board. In some such embodiments, collaboration system 101 periodically queries and analyzes the files or records to determine if any changes satisfy the configured state changes or events for triggering the collaborative board creation.

Process 400 includes detecting (at 406) a configured (at 402) state change or event. Specifically, collaboration system 101 detects (at 406) that specific data tracked by external systems 301 satisfy the values, conditions, or thresholds configured (at 402) for triggering the creation of a collaborative board.

Process 400 includes determining (at 408) a particular recipient that is associated with the detected state change or event. For instance, the detected state change may involve reaching a particular sales goal, and collaboration system 101 determines (at 408) the one or more individuals (e.g., the particular recipient) with sales totals or total sales that satisfy the particular sales goal. In other words, collaboration system 101 connects a detected state change or event to one or more individuals that caused or reached the state change, are involved in the event, and/or otherwise contributed to or are affected by the state change or event. In some embodiments, the particular recipient is identified by one or more of a name, email address, telephone number, social media handle, and/or other user identifier that is obtained from external systems 301 and/or analyzing the tracked state changes and/or events.

Process 400 includes selecting (at 410) a collaborative board template from different available templates based on the detected state change or event that initiates the collaborative board creation. Different templates may be associated with different state changes or events. For instance, collaboration system 101 may select (at 410) a first collaborative board template for a birthday event, a second collaborative board template for a promotion, and a third collaborative board template for reaching a performance milestone. Each template defines a positioning or arrangement for custom content and/or user contributions, background imaging, and/or customizations for the collaborative board.

Process 400 includes generating (at 412) custom content for the collaborative board based on one or more custom content fields in the selected (at 410) collaborative board template, the particular recipient, and/or the state change or event triggering the collaborative board creation. Generating (at 412) the custom content includes entering thematic content that identifies the state change or event being recognized or celebrated. For instance, the custom content may specify “Happy 10^{th} Anniversary” when the triggering state indicates the particular recipient reaching a 10 year anniversary, and may specify “Top Sales Agent for the Year” when the triggering event involves identifying the agent with the most sales. Generating (at 412) the custom content further includes entering identifying information about the particular recipient in the collaborative board. The identifying information may include the name of the particular recipient so that contributors are aware who the collaborative board is for. Additionally, the selected (at 410) collaborative board template may include fields for inserting a picture selected according to one or more of the particular recipient and/or the detected state change or event. For instance, a collaborative board template for a retirement event or 20 year anniversary may specify customizing the collaborative board with the first or new hire image of the particular recipient, whereas a collaborative board template for the release of a new product may specify customizing the collaborative board with an image of the product or a group photograph of the team members that designed the product. Collaboration system 101 retrieves the images from external system 301.

Process 400 includes detecting (at 414) relevant individuals for contributing to the collaborative board being generated for the particular recipient. Collaboration system 101 detects (at 414) the relevant individuals based on relationships established between the relevant individuals and the particular recipient in external systems 301 and/or the relevance of relationships to the detected state or event. In other words, not all individuals that have a relationship with the particular recipient are selected as relevant individuals for contributing to the collaborative board. Collaboration system 101 excludes individuals that have distant, remote, or inconsequential relationships to the particular recipient or the detected state or event. Accordingly, the relevant individuals with established relationships may include individuals on the same team, in the same department, in the same role as the particular recipient, direct managers or supervisors of the particular recipient, employees managed by the particular recipient, frequent contacts of the particular recipient, individuals that have recently worked, collaborated with, or communicated with the particular recipient, family member, personal or business acquaintances, and/or other entities with verifiable interaction with the particular recipient.

Collaboration system 101 differentiates the relevant individuals from all individuals that have a relationship with the particular recipient in order to increase the emotional value or meaning of the contributions that are added to the collaborative board. Receiving a generic congratulatory message from someone that one does not care about or is unfamiliar with does not add much if any emotional value or meaning to the collaborative board. Accordingly, filtering the set of contributors to the relevant individuals makes the contributions more meaningful and impactful to the particular recipient and is likely to elicit a greater overall emotional response. In other words, rather than have each and every employee of a company that may or may not have interacted with the particular recipient contribute a generic message, collaboration system 101 filters the contributors to include those individuals that the particular recipient knows and cares about.

Process 400 includes distributing (at 416) the collaborative board with the generated custom content to the relevant individuals for additional contributions from the relevant individuals. Distributing (at 416) the collaborative board may include sending an email, text message, or other electronic message with a link to each relevant individual. The link provides access to the collaborative board, and each relevant individual may contribute different content to the collaborative board in recognition or celebration of the configured state or event for the particular recipient.

Process 400 includes receiving (at 418) the contributions from the relevant individuals. As noted above, the contributions include text, images, videos, audio, graphics, animations (e.g., memes, gifs, and the like), interactive widgets, and/or content in other formats. Additionally, the contributions may include financial or monetary contributions. In some embodiments, collaboration system 101 tags each contribution with an identifier that identifies the contributor for that contribution. Collaboration system 101 may use the tags to rank

Process 400 includes arranging (at 420) the contributions on the collaborative board based on the relationships between the relevant individuals and the particular recipient and/or a sentiment analysis of the contributions. Arranging (at 420) the contributions involves performing an intelligent curation of the contributions to position, at the top and front of the collaborative board, the contributions that are determined based on the relationships to be more meaningful to the particular recipient. For instance, collaboration system 101 places contributions from members in the same team or department closer to the top of the collaborative board than contributions from members of other teams or departments. Similarly, collaboration system 101 positions contributions from direct supervisors or individuals that worked with the particular recipient for a long period of time closer to the top of the collaborative board than contributions from entry-level individuals or individuals that have recently began working with the particular recipient.

In some embodiments, collaboration system 101 also performs a sentiment analysis on the contributions to surface the contributions to the top and front of the collaborative board that are more expressive while lowering the contributions that are less expressive or more generic. For instance, collaboration system 101 determines that a video message contribution that is 20 seconds in length and includes 3 different relevant individuals has more emotional importance than a three word generic textual message of “Congratulation! Great Work!”. The sentiment analysis includes analyzing the length of textual messages, the adjectives used in the textual messages, the expressions, tone, and length of video and audio messages, the number of individuals in video and audio messages, specific descriptive words versus the usage of generic terms, and/or criteria to rank each contribution.

Arranging (at 420) the contributions includes adding the contributions to the collaborative board according to a layout or format specified by the selected (at 410) collaborative board template. For instance, a first collaborative board template may specify arranging the contributions in an aligned two column format, and a second collaborative board template may specify arranging the contributions in a staggered or offset three column format. Collaboration system 101 dynamically determines in what order to position the contributions based on the determined ranks in the specified layout or format of the selected (at 410) collaboration board template.

In some embodiments, arranging (at 420) the contributions includes adjusting the size of different contributions based on the rank or determined importance of the contributions. For instance, collaboration system 101 may increase the font size of textual message from a company executive or direct supervisor relative to a textual message from a team member, or may increase the font size of a more expressive textual message relative to a less expressive textual message. Collaboration system 101 also distributes the ranked contributions over the collaborative board so that there is even distribution of different formatted content across the layout.

In any case, arranging (at 420) the contributions differentiates the collaborative board from a social media feed because the contributions are not placed on the collaborative board in the order that they are received as they are in the social media feed. Collaboration system 101 arranges (at 420) the contributions to elicit the greatest emotional response from the particular recipient by analyzing the contributions based on relevance or importance to the particular recipient. The arranged collaborative board also elicits a greater emotional response than a social media feed that simply presents one contribution after another sequentially by, instead, grouping and presenting meaningful and relevant contributions together in the same space and/or at the same time.

Process 400 includes determining (at 422) whether the generated collaborative board satisfies a content threshold. Collaboration system 101 compares the contributions arranged over the generated collaborative board to other collaborative boards generated for the same detected state or event for other recipients. From the comparison, collaboration system 101 determines if a sufficient number of contributions have been received from a sufficient number of contributors to ensure that the particular recipient is properly recognized or celebrated. In other words, collaboration system 101 prevents one recipient from receiving a collaborative board with 100 contributions and another recipient from receiving a collaborative board with only 10 contributions for reaching the same state or event. Variances in the content threshold may be set based on the recipient role. For instance, a chief executive officer is expected to receive a greater number of contributions than a beginning level employee. However, individuals at the same level or that reach common milestones are expected to receive a proportionate or about equal number of contributions.

In response to determining (at 422—Yes) that the generated collaborative board satisfies the content threshold, process 400 includes presenting (at 424) the generated collaborative board to the particular recipient. In some embodiments, presenting (at 424) the generated collaborative board includes displaying a digital representation of the collaborative board with the audio, video, and animated contributions playing when hovered over, clicked on, or brought within a specific field-of-view. In some embodiments, presenting (at 424) the generated collaborative board includes printing the collaborative board to a physical medium (e.g., a card, poster, book, etc.), and presenting the physical medium to the particular recipient.

In response to determining (at 422—No) that the generated collaborative board does not satisfy the content threshold, process 400 includes requesting (at 426) additional contributions from the relevant individuals or from additional individuals. Collaboration system 101 continues gathering the contributions until the content threshold is reached or a due date is reached.

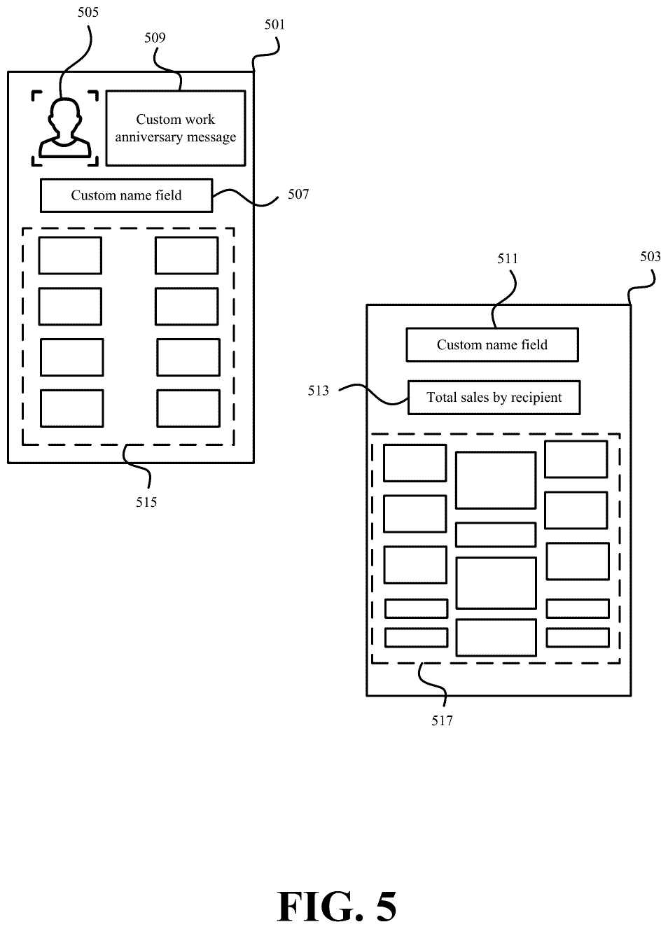

FIG. 5 illustrates an example of different collaborative board templates 501 and 503 for different configured states or events in accordance with some embodiments presented herein. First collaborative board template 501 is associated with a work anniversary event, and second collaborative board template 503 is associated with a sales milestone state. Each template 501 and 503 includes different custom content fields, and specifies different layouts for received contributions.

The custom content fields of template 501 include first field 505 for presenting a new hire image of the recipient celebrating the work anniversary, second field 507 for presenting the recipient name, and third field 509 for presenting a custom message to celebrate the work anniversary event. Collaboration system 101 automatically retrieves the new hire image and recipient name from one or more external systems 301.

The custom content fields of template 503 include first field 511 for presenting the recipient name, and second field 513 for presenting the sale milestone reached by that recipient. Accordingly, collaboration system 101 automatically retrieves different data from external systems 301 when generating a collaborative board based on template 501 or based on template 503.

Each template 501 and 503 specifies a different positioning, sizing, and/or formatting for the custom fields 505, 507, 509, 511, and 513. Moreover, each template 501 and 503 may select between a different set of background images based on the different states or events associated with each template 501 and 503.

Template 501 defines a two column aligned layout 515 for presenting the received contributions, and template 503 defines a three column offset layout 517 for presenting the received contributions. Moreover, the two column aligned layout 515 of template 501 presents the arranged contributions with equal sizes, whereas the three column offset layout 517 of template 503 presents the arranged contributions with different sizes.

Collaboration system 101 sizes and positions the contributions for template 501 according to the specified two column aligned layout 515. Collaboration system 101 sizes and positions the contributions for template 503 according to the specified three column offset layout 517. In distributing the contributions across the specified layout, collaboration system 101 ensures that the columns are of equal length and/or have a similar number of contributions amongst them.

Collaboration system 101 performs an intelligent curation of contributions in determining where to place to each contribution within the collaborative board. As noted above, collaboration system 101 does not simply place the contributions on the collaborative board in the order the contributions are received, but rather arranges the contributions based on determined relationships between the contributor, the recipient, and/or the recognized state or event, and based on a sentiment analysis of the contributions. In some embodiments, collaboration system 101 also changes the size, formatting, and/or other visual characteristics of the contributions based on the determined relationships and sentiment analysis in order to further increase or decrease the impact or impression that different contributions impart to the recipient.

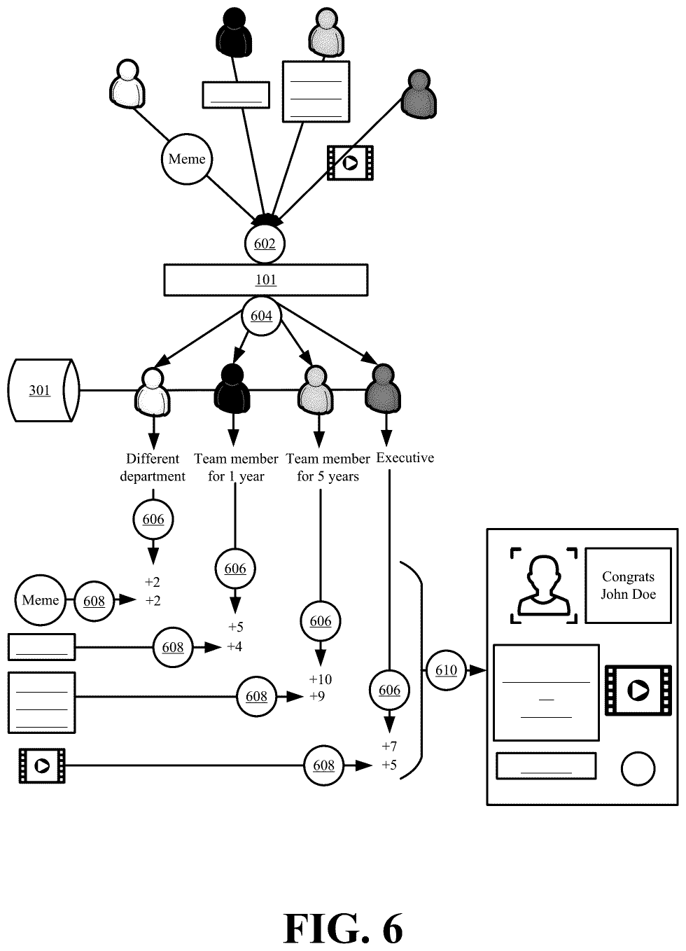

FIG. 6 illustrates an example of the intelligent contribution curation performed by collaboration system 101 in accordance with some embodiments presented herein. Collaboration system 101 receives (at 602) a set of contributions from different contributors for inclusion in the collaborative board that is being generated for a particular recipient. Collaboration system 101 may receive (at 602) two or more of the set of contributions at the same time or at different times.

Collaboration system 101 determines (at 604) a relationship between each contributor and the recipient. In some embodiments, collaboration system 101 receives the email address, telephone number, name, or other identifier for the contributor of each contribution, and performs a lookup of the identifier in external systems 301 to determine (at 604) the relationship between the contributor and the recipient.

Collaboration system 101 ranks (at 606) the contributions based on the closeness and/or importance of each relationship. Collaboration system 101 may be configured with a formula or equation for quantifying a rank from the closeness and/or importance of each relationship. For instance, different weights may be given based on a number of years the recipient and contributor have known each other and based on roles of the recipient and the contributor. For instance, collaboration system 101 attributes a higher ranking to contributions from those closest to the recipient. Those closest to the recipient may include family members that have the same last name, individuals that have worked on the same team as the recipient for the longest period of time, individuals in the same department as the recipient, direct reports, supervisors, or managers of the recipient, and/or other individuals with special roles (e.g., executives within an organization).

Collaboration system 101 performs (at 608) the sentiment analysis on each contribution. The sentiment analysis varies depending on the contribution format. For instance, the sentiment analysis for a textual message may include detecting the adjectives used in the message as well the descriptiveness or genericness of the textual message. The sentiment analysis for video and audio message may include detecting the expressions, tone, and length of the messages as well as the number of individuals in the message. Performing (at 608) the sentiment analysis includes adjusting the rankings and/or determining a secondary score with which to rank the contributions.

Collaboration system 101 dynamically generates (at 610) the collaborative board with the received contributions arranged according to the determined rankings and the layout specified in the collaborative board template. Dynamically generating (at 610) the collaborative board includes raising to the top of the collaborative board those contributions that are the most descriptive, use expressive adjectives, and/or involve the closest or most important individuals to the recipient, and lowering to the bottom of the collaborative board those contributions that are generic, contain the fewest words, are the shortest length, and/or the individuals with remote relationships to the recipient. Dynamically generating (at 610) the collaborative board further includes increasing the font size of the higher ranked textual messages relative to the lower ranked textual messages, increasing the size of videos that are higher ranked relative to lower ranked videos, increasing the size of images, memes, gifs, and/or other content that are ranked higher than other images, memes, gifs, and/or other content. Accordingly, the contributions that are determined to elicit the greatest emotional response from the recipient are grouped together and presented first, and the contributions that are from more remote contacts or that are more generic and therefore of lesser emotional value are presented lower down the collaborative board.

In some embodiments, collaboration system 101 supports configurable custom fields within the templates for receiving supplemental information as to the contributors or contributions for a particular collaborative board. The supplemental information may include statistics that collaboration system 101 uses for the intelligent contribution curation and organization. The supplement information may also include identifying information about the contributions or contributors that collaboration system 101 uses for the intelligent contribution curation and organization. For instance, an administrator may define a configurable custom field that asks the contributors to provide their name or their relationship to the recipient when adding a contribution to the collaborative board.

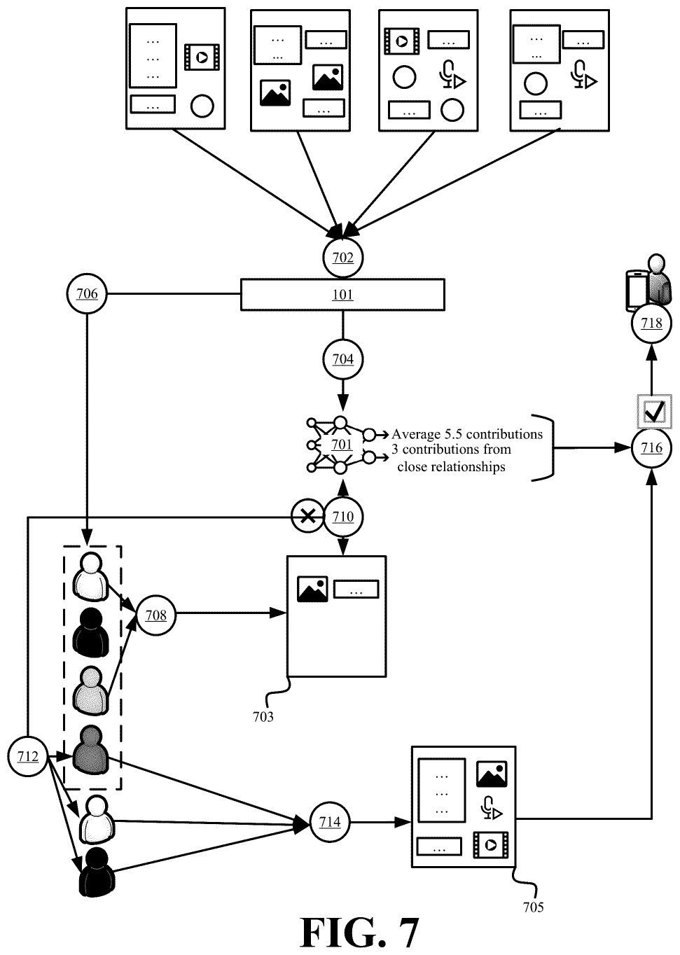

In some embodiments, collaboration system 101 uses one or more artificial intelligence and/or machine learning (“AI/ML”) techniques to establish the content threshold by which the quality of the collaborative boards is automatically assessed and verified. FIG. 7 illustrates an example of verifying the quality of an automatically generated collaborative board based on an AI/ML derived content threshold in accordance with some embodiments presented herein.

Collaboration system 101 aggregates (at 702) a set of collaborative boards that are created and presented to different recipients for the recognition, celebration, and/or acknowledgement of a particular state change or event or similar state changes or events. For instance, collaboration system 101 aggregates (at 702) 10 collaborative boards that were created and presented to recipients celebrating their 5^{th} through 10^{th} work anniversaries.

Collaboration system 101 analyzes (at 704) the content and/or contributions within each of the set of collaborative boards aggregated for the particular state change or event. Analyzing (at 704) the contributions may include using one or more AI/ML techniques to determine patterns, trends, and/or other commonality in the contributions include each collaborative board. The AI/ML techniques may generate model 701 that identifies the common elements within the set of collaborative boards. For instance, model 701 may specify an average number of contributions across the set of collaborative boards, the percentage of contributions for very close individuals and more distance individuals, the percentage of highly ranked (e.g., descriptive, expressive, etc.) contributions versus lower ranked contributions, specific contributors (e.g., the direct manager, the chief executive officer, all members in a given team, etc.) found in each collaborative board.

When generating a new collaborative board for the particular state change or event, collaboration system 101 retrieves model 701 that was generated for that particular state change or event, and compares the contributions received for the new collaborative board against the model. If the received contributions do not meet or exceed the modeled elements, collaboration system 101 performs various actions to remedy the deficiencies.

As shown in FIG. 7, collaboration system 101 requests (at 706) contributions from a first set of contributors, and generates (at 708) first collaborative board 703 based on a first set of received contributions. Collaboration system 101 determines that first collaborative board 703 is generated for the particular state change or event represented by model 701, compares (at 710) contributions within first collaborative board 703 against the modeled contributions in model 701 for collaborative boards directed to the particular state change or event.

Based on the comparison (at 710), collaboration system 101 determines that first collaborative board 703 has an insufficient number of contributions and appears bare compared to other collaborative boards for the same state change or event. Accordingly, collaboration system 101 requests (at 712) contributions from additional relevant individuals or previously requested relevant individuals that have yet to submit a contribution. If the new collaborative board is missing a contribution from a specific important individual, collaboration system 101 may issue a targeted reminder to that specific important individual to contribute to the collaborative board. Similarly, if the new collaborative board does not have a video message and model 701 specifies all other collaborative boards for the same particular state change or event having a video message, then collaboration system 101 may notify an administer or various contributors that the video message is missing from the new collaborative board.

Collaboration system 101 receives additional contributions, and updates (at 714) first collaborative board 703 to include the additional contributions. Updating (at 714) first collaborative board 703 includes generating second collaborative board 705 with a reordering of the collective set of contributions determined based on each contribution ranking.

Collaboration system 101 compares (at 716) second collaborative board 705 to model 701, determines that second collaborative board 705 satisfies the modeled requirements for collaborative boards directed to the particular state change or event, and presents (at 718) second collaborative board 705 to the targeted recipient.

In some embodiments, collaboration system 101 analyzes the generated collaborative boards to track user engagement, contentment, and/or state. In some such embodiments, collaboration system 101 tracks user engagement across different collaborative boards that are generated for a group, team, or other organization that each user is associated with, performs a sentiment analysis on the tracked engagement, and derives a user score based on the tracked user engagement and the sentiment analysis.

The user score is an assessment that allows collaboration system 101 or administrators or managers associated with the organization to track user engagement, contentment, and/or state. Specifically, the user score differentiates users that actively and enthusiastically involved in the organization versus users that may feel left out, are disengaged, and/or may be at risk of leaving the organization. Collaboration system 101 may perform various automated actions to reengage the disengaged users, better incorporate them within the organization culture, and improve the overall collaborative environment or morale.

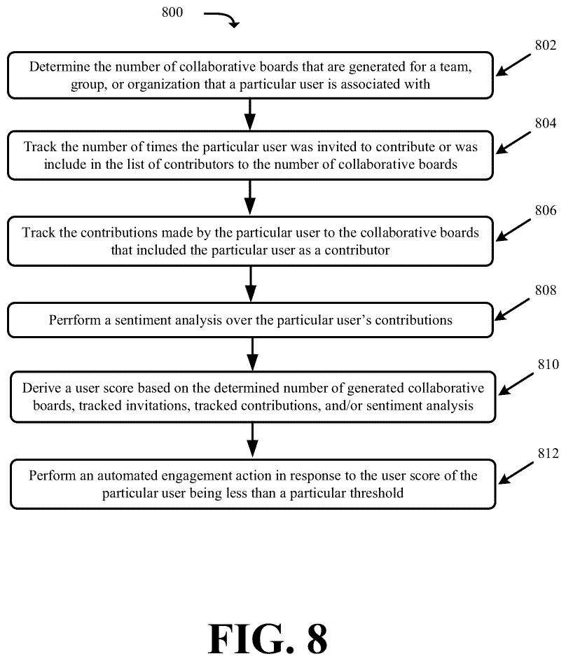

FIG. 8 presents a process 800 for assessing user state from the generation of collaborative board in accordance with some embodiments presented herein. Process 800 is implemented by collaborative system 101.

Process 800 includes determining (at 802) the number of collaborative boards that are generated for a team, group, or organization that a particular user is associated with. For instance, collaborative system 101 determines (at 802) the number of collaborative boards that are generated for the department, division, or team of the particular user.

Process 800 includes tracking (at 804) the number of times the particular user was invited to contribute or was include in the list of contributors to the determined (at 802) number of collaborative boards. The number of invitations may be indicative of the particular user's visibility within the team, group, or organization, or how other users within the team, group, or organization treat or feel about the particular user, and serves as a first measure of engagement and/or contentment.

Process 800 includes tracking (at 806) the contributions made by the particular user to the collaborative boards that included the particular user as a contributor. In some embodiments, collaborative system 101 computes the ratio for the number of times the particular user was invited to contribute to a collaborative board and the number of times the particular user responded to the invitation and provided a contribution. The ratio is a second measure of the particular user's engagement and/or contentment with the team, group, or organization.

Process 800 includes performing (at 808) a sentiment analysis over the particular user's contributions. The sentiment analysis is based on expressiveness or genericness of the contributions. For instance, a contribution with a generic “Congratulations” or “Happy Birthday” is provided a lower sentiment score than a more expressive contribution that uses multiple adjectives, includes pictures, and/or other custom content. The sentiment score is a third measure of user engagement or contentment.

Process 800 includes deriving (at 810) a user score based on the determined (at 802) number of generated collaborative boards, tracked (at 804) invitations, tracked (at 806) contributions, and/or sentiment analysis. The user score indicates how involved the particular user is with their team, group, or organization, serves as a measure of the particular user's contentment within the team, group, or organization, and/or serves a risk measure for the likelihood of the particular user leaving the team, group, or organization. Users that are routinely recognized by other team members and/or that actively engage or interact with other team members via the generated collaborative boards are more likely to enjoy the team, group, or organization they work within and produce better work quality, whereas a user that is disengaged and/or does not actively collaborative or support other team members may be happier and more productive elsewhere.

Accordingly, process 800 include performing (at 812) an automated engagement action in response to the user score of the particular user being less than a particular threshold. Performing (at 812) the automated engagement action includes better engaging, integrating, and/or incorporating the particular user within the team, group, or organization. In other words, performing (at 812) the automated engagement action causes the particular user to collaborate and become more visible within their own team, group, or organization. For instance, performing (at 812) the automated engagement action includes automatically inviting the particular user to contribute to a higher ration of collaborative boards that are generated for the team, group, or organization. In some embodiments, performing (at 812) the automated engagement includes generating and suggesting more expressive custom content for the particular user to select from and add to another team member's collaborative board. In some other embodiments, performing (at 812) the automated engagement includes notifying administrators or managers of the particular user's lack of engagement so that the administrators or managers are made aware of the situation. The administrators or manager may then take actions to motivate and encourage more participation from the particular user so that the particular user becomes a closer member of team and is more willing to voluntarily engage with their team. This may include having a manager or human resources address issues that the particular user may be having within their team, group, or organization, and offer support to improve the particular user's productivity and/or contentment within the team, group, or organization.

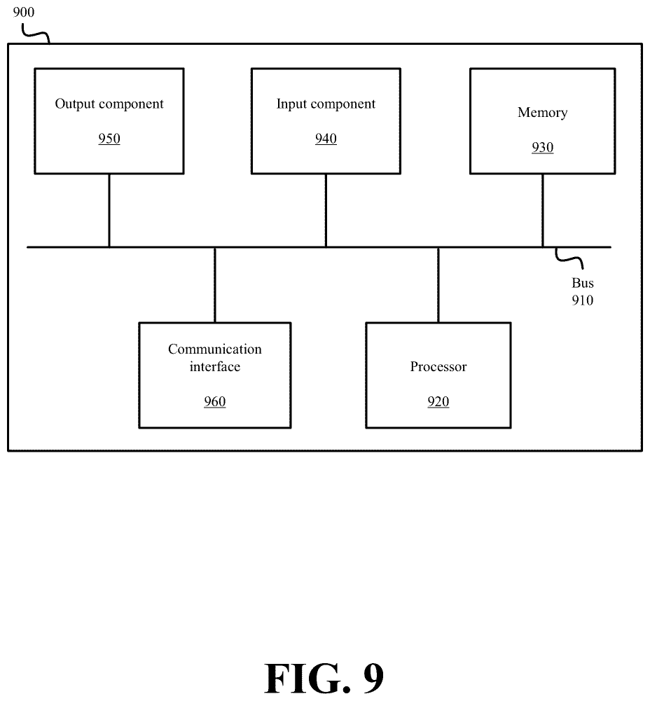

FIG. 9 is a diagram of example components of device 900. Device 900 may be used to implement one or more of the devices or systems described above (e.g., collaboration system 101, external systems 301, user devices, etc.). Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more LEDs, etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
monitoring, at a collaboration system, a plurality of state changes and events associated with a plurality of different individuals that are updated in one or more external systems;
detecting, by operation of the collaboration system, a particular state change or event associated with a particular individual that satisfies a configured threshold;
selecting, by operation of the collaboration system, a set of individuals from the plurality of different individuals that have one of a specified set of relevant relationships with the particular individual;
issuing, from the collaboration system, a request for a contribution to a device of each individual from the set of individuals over a data network;
receiving, at the collaboration system, contributions from the set of individuals in a first order;
generating, by operation of the collaboration system, a single visualization that includes the contributions from the set of individuals in a different second order; and
presenting the single visualization to the particular individual.

2. The method of claim 1 further comprising:
ranking the contributions provided by the set of individuals based on a different relationship that each individual from the set of individuals has with the particular individual; and
arranging the contributions in the second order based on the ranking.

3. The method of claim 1 further comprising:
analyzing a sentiment expressed in each contribution of the contributions;
ranking the contributions according to the sentiment; and
arranging the contributions in the second order based on the ranking.

4. The method of claim 1, wherein generating the single visualization comprises:
positioning the contributions in at least two side-by-side columns based on one or more of (i) a relationship between an individual providing a contribution and the particular individual, and (ii) sentiment expressed in each contribution.

5. The method of claim 1 further comprising:
printing the single visualization onto a physical medium.

6. The method of claim 1 further comprising:
aggregating a plurality of visualizations generated for different individuals associated with the particular state change or event;
generating a model based on commonality within the plurality of visualizations;
comparing the contributions of the single visualization against the model; and
requesting additional contributions from additional individuals in response to the contributions of the single visualization differing from the commonality within the plurality of visualizations.

7. The method of claim 6, wherein requesting the additional contributions comprises:
determining that the single visualization lacks a contribution from an individual with a particular relationship as a result of said comparing; and
issuing the request to the individual.

8. The method of claim 6, wherein requesting the additional contributions comprises:
determining that the contributions of the single visualization is less than a threshold number of contributions determined from the commonality of the plurality of visualizations; and
adding the additional contributions to the single visualization until the threshold number of contributions is reached.

9. The method of claim 1, wherein receiving the contributions comprises:
receiving a textual message from a first individual of the set of individuals; and
receiving at least one of a video message, an audio message, or a graphical message from a second individual of the set of individuals.

10. The method of claim 9,
wherein receiving the contributions further comprises receiving monetary contributions from a subset of the set of individuals; and
wherein presenting the single visualization comprises transferring a sum of the monetary contributions to the particular individual.

11. The method of claim 1 further comprising:
configuring a specific set of state changes and events that trigger creation of the single visualization; and
wherein detecting the particular state change or event comprises determining that particular state change or event associated with the particular individual satisfies the configured threshold associated with one of the specific set of state changes or events.

12. The method of claim 1, wherein generating the single visualization comprises:
raising a first subset of the contributions in the single visualization from a first subset of the set of individuals that are determined to have a closer relationship with the particular individual than a second subset of the set of individuals; and
lowering a second subset of the contributions in the single visualization from the second subset of individuals that are determined to have a more distant relationship with the particular individual than the first subset of individuals.

13. A system comprising:
one or more hardware processors configured to:
monitor a plurality of state changes and events associated with a plurality of different individuals that are updated in one or more external systems;
detect a particular state change or event associated with a particular individual that satisfies a configured threshold;
select a set of individuals from the plurality of different individuals that have one of a specified set of relevant relationships with the particular individual;
issue a request for a contribution to a device of each individual from the set of individuals over a data network;
receive contributions from the set of individuals in a first order;
generate a single visualization that includes the contributions from the set of individuals in a different second order; and
present the single visualization to the particular individual.

14. The system of claim 13, wherein the one or more hardware processors are further configured to:
rank the contributions provided by the set of individuals based on a different relationship that each individual from the set of individuals has with the particular individual; and
arrange the contributions in the second order based on the ranking.

15. The system of claim 13, wherein the one or more hardware processors are further configured to:
analyze a sentiment expressed in each contribution of the contributions;
rank the contributions according to the sentiment; and
arrange the contributions in the second order based on the ranking.

16. The system of claim 13, wherein generating the single visualization comprises:
positioning the contributions in at least two side-by-side columns based on one or more of (i) a relationship between an individual providing a contribution and the particular individual, and (ii) sentiment expressed in each contribution.

17. The system of claim 13 further comprising:
a printer that prints the single visualization onto a physical medium.

18. The system of claim 13, wherein the one or more hardware processors are further configured to:
aggregate a plurality of visualizations generated for different individuals associated with the particular state change or event;
generate a model based on commonality within the plurality of visualizations;
compare the contributions of the single visualization against the model; and
request additional contributions from additional individuals in response to the contributions of the single visualization differing from the commonality within the plurality of visualizations.

19. The system of claim 18, wherein requesting the additional contributions comprises:
determining that the contributions of the single visualization is less than a threshold number of contributions determined from the commonality of the plurality of visualizations; and
adding the additional contributions to the single visualization until the threshold number of contributions is reached.

20. A non-transitory computer-readable medium storing program instructions that, when executed by one or more hardware processors of a collaboration system, cause the collaboration system to perform operations comprising:
monitor a plurality of state changes and events associated with a plurality of different individuals that are updated in one or more external systems;
detect a particular state change or event associated with a particular individual that satisfies a configured threshold;
select a set of individuals from the plurality of different individuals that have one of a specified set of relevant relationships with the particular individual;
issue a request for a contribution to a device of each individual from the set of individuals over a data network;
receive contributions from the set of individuals in a first order;
generate a single visualization that includes the contributions from the set of individuals in a different second order; and
present the single visualization to the particular individual.
